(19) United States
(12) Patent Application Publication
(10) Pub. No.: US 2024/0281631 A1
(43) Pub. Date: Aug. 22, 2024

(54) System and Related Methods for Tracking Usage and Provenance Information for one or More Garments

(71) Applicant: Evan Michael Kellner, Atlanta, GA (US)

(72) Inventor: Evan Michael Kellner, Atlanta, GA (US)

(21) Appl. No.: 18/111,619

(22) Filed: Feb. 20, 2023

(51) Int. Cl. G06K 19/02; G06K 19/077

(52) U.S. Cl. CPC G06K 19/027; G06K 19/07758

(57) ABSTRACT

The present disclosure provides a system for tracking usage and provenance information for one or more garments in the from of a set of one or more tags or “logbooks”, each intended to have an associated garment. Each tag is embossed with a set of information to facilitate easy recording and tracking of provenance and usage information related to the associated garment for later reference. The same tags including the same information can also be printed directly onto the fabric of the garment.

### FIELD OF INVENTION

The present invention relates generally to the field of clothing accessories and tracking. More specifically, the present invention relates to a tracking system comprising one or more writeable tags embossed with tracking information and a method of embossing the information of said tags directly onto a garment.

### BACKGROUND

Certain types of clothing, in particular garments made of denim, become more aesthetically appealing to some owners over time due to the characteristic fading of colors in the fabric.

While particularly prevalent in denim clothing, the trend for a wearer's attachment to an item of clothing to grow over time and across multiple uses occurs often with high quality garments, especially when proper care is taken of the garment. However, the information relating to the garment and its history is often lost and forgotten over this time, leading to users forgetting how they acquired and treated garments that they have become very attached to.

Having a system for tracking usage, provenance, and treatment of such garments over a long period of time would allow owners to easily recall such details about their most precious garments and also to determine if the garment was treated properly and thus adjust their garment care approach. It is within this context that the present invention is provided.

### SUMMARY

The present disclosure provides a system for tracking usage and provenance information for one or more garments in the from of a set of one or more tags or “logbooks”, each intended to have an associated garment. Each tag is embossed with a set of information to facilitate easy recording and tracking of provenance and usage information related to the associated garment for later reference. The same tags can also be printed directly onto the fabric of the garment. including the same information

Thus, according to one aspect of the present disclosure there is provided a system for tracking usage and origin details for one or more associated garments, the system comprising one or more tags each formed of a markable material, wherein each tag is embossed with a first grid for recording the number of times an associated garment has been worn and a second grid for recording the number of times the associated garment has been washed.

In some embodiments, one or more of the tags is further embossed with a section for recording the brand of the associated garment.

In some embodiments, wherein one or more of the tags is further embossed with a section for recording the style of the associated garment.

In some embodiments, one or more of the tags is further embossed with a section for recording the date of purchase or acquisition of the associated garment.

In some embodiments, wherein one or more of the tags is further embossed with a section for recording the country of origin of the associated garment.

In some embodiments, one or more of the tags is further embossed with a section for recording the fit of the associated garment.

In some embodiments, one or more of the tags is further embossed with a section for recording the number of soaks performed on the associated garment.

In some embodiments, one or more of the tags is further embossed with a section for recording the date of the first wash of the associated garment.

In some embodiments, one or more of the tags is further embossed with a section for indicating whether the fabric of the associated garment is selvedge.

In some embodiments, one or more of the tags is further embossed with a section for indicating whether the fabric of the associated garment is raw denim.

In some embodiments, one or more of the tags is further embossed with a section for recording notable wears or other related information of the associated garment.

In some embodiments, the material is one or more of leather, cork, vegan leather, card, or paper.

In some embodiments, one or more of the tags comprises an adhesive or hooked element for attaching the tag to the associated garment.

According to another aspect of the present disclosure there is provided a method for tracking usage and origin details for one or more garments, the method comprising the steps of embossing each garment with a first grid for recording the number of times an associated garment has been worn and a second grid for recording the number of times the associated garment has been washed.

The first grid and the second grid may be printed onto a cotton, polyester, Spandex, or Rayon material of the garment.

### BRIEF DESCRIPTION OF THE DRAWINGS

Various embodiments of the invention are disclosed in the following detailed description and accompanying drawings.

FIG. 1 illustrates an isometric view of a first example configuration of a tag in accordance with the system of the present disclosure.

FIG. 2 illustrates an isometric view of a second example configuration of a tag in accordance with the system of the present disclosure.

FIG. 3 illustrates an isometric view of a third example configuration of a tag in accordance with the system of the present disclosure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The system of the present invention comprises one or more tags or “logbooks” which are pre-embossed with a structured set of information to fill out and record in relation to an associated garment. This facilitates the recording of a garment's history which can increase their bond with precious garments.

The tracking information can also include tracking of care information such as washes and soaks. This can encourage owners to take better care of their garments or, by looking at the current condition of a garment and the history recorded on the associated tag, allow them to determine if a certain care routine was beneficial to the long term appearance and condition of the garment.

Finally, provenance information can be recorded. Having a record of the provenance information can, for example, allow a garment owner to tell the quality of brands and manufacturing countries by comparing the condition of a set of garments and glancing at their associated tags.

Each tag is made out of a flexible, durable material which can easily be written on using permanent ink. Such materials can include but are not limited to: leather, vegan leather, cork, card, and paper.

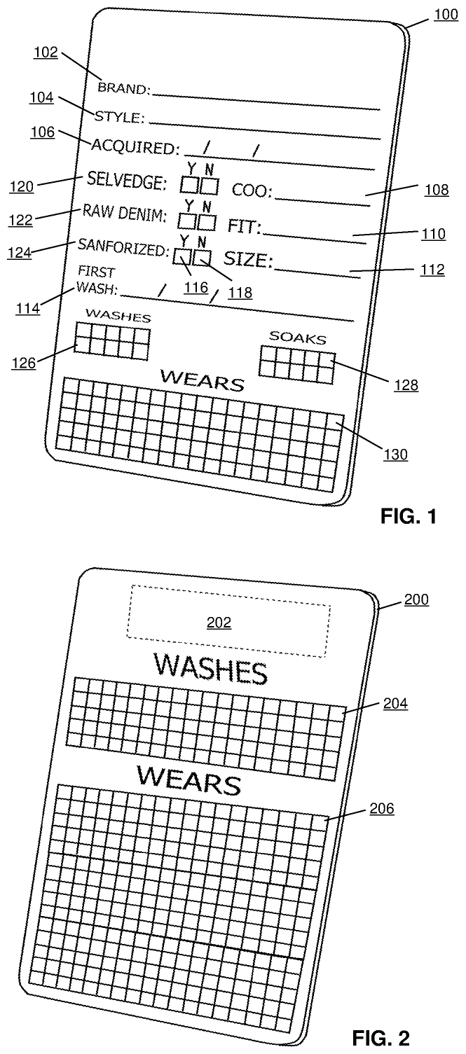

FIGS. 1 to 3 show a set of different example configurations of the pre-embossed information structure for these tags/logbooks. Different configurations may be suitable for different types of garments or target markets.

The illustrated configurations are merely exemplary, and could be subject to additions, subtractions, or reconfigurations of the embossed information.

Thus, referring to FIG. 1, an isometric view of a first example configuration of a tag 100 is shown in accordance with the system of the present disclosure.

The first tag configuration 100 comprises a relatively thorough listing of potentially useful provenance data, data on the garment itself, and tracking grids for allowing a user to mark and track care/wear events for the associated garment.

As can be seen, a blank line is left for a user to fill out information on the brand 102, style 104, acquisition date 106, country of origin 108, fit 110, size 112, and first wash date 114 of the associated garment.

Furthermore, yes “Y” boxes 116 and no “N” boxes 118 are provided for indicating a number of details about the fabric of the associated garment including whether or not it is selvedge 120, raw denim 122, or sanforized 124.

Selvedge refers to a “self-finished” edge of a piece of fabric which keeps it from unraveling and fraying. The term “self-finished” means that the edge does not require additional finishing work, such as hem or bias tape, to prevent fraying. Sanforization is a process of pre-shrinking fabric before it is made into a garment. When a fabric has been treated with the sanforization process, it's referred to as ‘sanforized’ or ‘pre-shrunk.’ If denim is not sanforized, it's referred to as ‘unsanforized’ or ‘shrink-to-fit’.

Finally, three grids are provided at the bottom of the tag 100. One grid 126 allows a garment owner to mark the number of washes the associated garment has undergone, a second grid 128 indicates the number of soaks the associated garment has undergone, and a third grid 130 indicates the number of times the associated garment has been worn.

Together, all of this information provides a useful at-a-glance summary of the associated garment's information as well as providing an increased sense of history for the owner.

Because the tag is made of a flexible, durable material, it may in some cases (not illustrated) comprise a hooked or adhesive element for actually attaching to the associated garment. This element could be a snap fitting, a loop, or any other kind of common attachment mechanism for garment accessories.

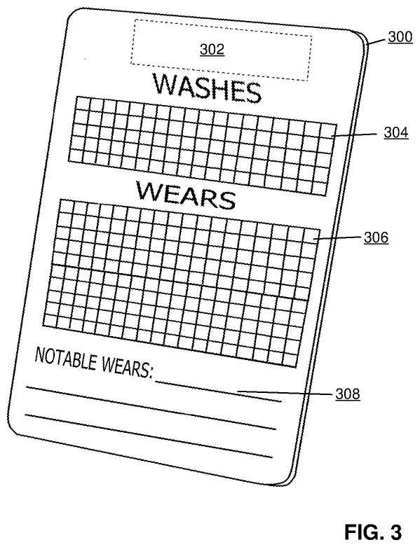

To reiterate, the configuration of embossed information provided on the illustrated tag is exemplary. Two further, simpler examples are provided by FIGS. 2 and 3.

Thus, referring to FIG. 2, an isometric view of a second example configuration of a tag 200 is shown in accordance with the system of the present disclosure.

The tag 200 has a blank space 202 at the top in which any desired information may be entered. In some examples, this space may be pre-embossed with a brand of the associated garment.

The tag 200 also has a first grid 204 for a garment owner to indicate the number of washes an associated garment has undergone and a second grid 206 for indicating the number of wears an associated garment has undergone.

As can be seen, the second tag configuration 200 comprises far less provenance and garment information and focuses on tracking the usage and care events for the associated garment, with a much larger grid provided for marking off both washes and wears.

Configurations such as that shown in FIG. 2 may thus be more useful for tracking long term usage of garments. Such configurations could be provided in a kit alongside configurations such as the first for marking off wears and washes once the first configuration tag 100 is filled.

Finally, referring to FIG. 3, an isometric view of a third example configuration of a tag 300 is shown in accordance with the system of the present disclosure.

The tag in the third configuration 300 is very similar to the tag in the second configuration 200, comprising a blank space 302 at the top in which any desired information may be entered, a first grid 304 for a garment owner to indicate the number of washes an associated garment has undergone, and a second grid 306 for indicating the number of wears an associated garment has undergone.

The third configuration tag 300 further comprises a space with a set of lines 308 at the bottom of the tag for a user to indicate notable wears. These could be wears associated with vivid memories that the owner wishes to recall as being associated with the garment, or wears where the garment suffered large amounts of wear/damage/markings.

According to another aspect of the present disclosure there is provided a method for tracking usage and origin details for one or more garments, the method comprising the steps of embossing each garment with a first grid for recording the number of times an associated garment has been worn and a second grid for recording the number of times the associated garment has been washed.

The first grid and the second grid may be printed onto a cotton, polyester, Spandex, or Rayon material of the garment.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system for tracking garment provenance and usage have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for tracking usage and origin details for one or more associated garments, the system comprising one or more tags each formed of a flexible, markable material, wherein each tag is embossed with a first grid for recording the number of times an associated garment has been worn and a second grid for recording the number of times the associated garment has been washed.

2. A system according to claim 1, wherein one or more of the tags is further embossed with a section for recording the brand of the associated garment.

3. A system according to claim 1, wherein one or more of the tags is further embossed with a section for recording the style of the associated garment.

4. A system according to claim 1, wherein one or more of the tags is further embossed with a section for recording the date of purchase or acquisition of the associated garment.

5. A system according to claim 1, wherein one or more of the tags is further embossed with a section for recording the country of origin of the associated garment.

6. A system according to claim 1, wherein one or more of the tags is further embossed with a section for recording the fit of the associated garment.

7. A system according to claim 1, wherein one or more of the tags is further embossed with a section for recording the number of soaks performed on the associated garment.

8. A system according to claim 1, wherein one or more of the tags is further embossed with a section for recording the date of the first wash of the associated garment.

9. A system according to claim 1, wherein one or more of the tags is further embossed with a section for indicating whether the fabric of the associated garment is sanforised.

10. A system according to claim 1, wherein one or more of the tags is further embossed with a section for indicating whether the fabric of the associated garment is selvedge.

11. A system according to claim 1, wherein one or more of the tags is further embossed with a section for indicating whether the fabric of the associated garment is raw denim.

12. A system according to claim 1, wherein one or more of the tags is further embossed with a section for recording notable wears or other related information of the associated garment.

13. A system according to claim 1, wherein the material is one or more of leather, cork, vegan leather, card, or paper.

14. A system according to claim 1, wherein one or more of the tags comprises an adhesive or hooked element for attaching the tag to the associated garment.

15. A method for tracking usage and origin details for one or more garments, the method comprising the steps of embossing each garment with a first grid for recording the number of times an associated garment has been worn and a second grid for recording the number of times the associated garment has been washed.

16. A method according to claim 15, wherein the first grid and the second grid are printed onto a cotton, polyester, Spandex, or Rayon material of the garment.
